(19) United States
(12) Patent Application Publication
(10) Pub. No.: US 2025/0277995 A1
(43) Pub. Date: Sep. 4, 2025

(54) OPTICAL MODULATOR AND METHOD FOR MANUFACTURING OPTICAL MODULATOR

(71) Applicant: HAMAMATSU PHOTONICS K.K., Hamamatsu-shi (JP)

(72) Inventors: Takahiro SUGIYAMA, Hamamatsu-shi (JP); Yoshiro NOMOTO, Hamamatsu-shi (JP); Akiyoshi WATANABE, Hamamatsu-shi (JP)

(73) Assignee: HAMAMATSU PHOTONICS K.K., Hamamatsu-shi (JP)

(21) Appl. No.: 19/039,969

(22) Filed: Jan. 29, 2025

(30) Foreign Application Priority Data
Mar. 4, 2024 (JP) 2024-032316

(51) Int. Cl. G02F 1/061

(52) U.S. Cl. CPC G02F 1/061; G02F 2202/022

(57) ABSTRACT

An optical modulator includes a substrate, a conductive portion, and a modulation layer. The conductive portion includes a first electrode portion and a second electrode portion. The first electrode portion includes a first base portion, and a first pattern portion extending from the first base portion in a first direction. The second electrode portion includes a second base portion facing the first base portion in the first direction, and a second pattern portion that extends from the second base portion in the first direction and is arranged alternately with the first pattern portion in a 10 second direction. The first electrode portion further includes a first extension portion extending from the first base portion toward the second pattern portion in the first direction, and the second electrode portion further includes a second extension portion extending from the second base portion toward the first pattern portion in the first direction.

### TECHNICAL FIELD

An aspect of the present disclosure relates to an optical modulator and a method for manufacturing the optical modulator.

### BACKGROUND

An optical modulator described in Japanese Unexamined Patent Publication No. 2022-066803 includes a base layer, a conductive pattern layer that includes a plurality of periodically arranged pattern portions and is formed on the base layer, and a modulation layer which consists of an electro-optic polymer and is formed on the conductive pattern layer, and of which a refractive index varies due to application of an electric field. In this optical modulator, a phase of target light transmitting through the modulation layer can be modulated by changing the refractive index of the modulation layer by applying an electric field to the modulation layer by using the pattern portions.

### SUMMARY

### Technical Problem

In the optical modulator described above, it is required to stably modulate light. Here, an objective of an aspect of the present disclosure is to provide an optical modulator capable of stably modulating light, and a method for manufacturing the optical modulator.

### Solution to Problem

An optical modulator according to an aspect of the present disclosure is [1] “An optical modulator, including: a substrate; a conductive portion that includes a pattern structure portion having a periodic arrangement and is formed on the substrate; and a modulation layer that is formed by an electro-optic polymer and is formed on the substrate to cover at least the pattern structure portion, wherein the conductive portion includes a first electrode portion and a second electrode portion, the first electrode portion includes a first base portion, and a plurality of first pattern portions extending from the first base portion in a first direction orthogonal to a thickness direction of the substrate, the second electrode portion includes a second base portion facing the first base portion in the first direction, and a plurality of second pattern portions extending from the second base portion in the first direction and arranged alternately with the plurality of first pattern portions in a second direction orthogonal to the thickness direction of the substrate and the first direction, the pattern structure portion including the plurality of first pattern portions and the plurality of second pattern portions, and the first electrode portion further include a plurality of first extension portions extending from the first base portion toward the plurality of second pattern portions in the first direction, and the second electrode portion further include a plurality of second extension portions extending from the second base portion toward the plurality of first pattern portions in the first direction”.

In the optical modulator, since the modulation layer is formed by an electro-optic polymer that responds at a higher speed as compared with a liquid crystal, a phase of light can be modulated at a high speed. In addition, in the optical modulator, the first electrode portion includes the first extension portions extending from the first base portion toward the second pattern portions in the first direction, and the second electrode portion includes the second extension portions extending from the second base portion toward the first pattern portions in the first direction. According to this, it is possible to secure an interval between the first pattern portions and the second base portion, and an interval between the second pattern portions and the first base portion as compared with a case where the first extension portions and the second extension portions are not provided. When the intervals are secured, even when forming the pattern structure portion by using, for example, imprint lithography, a portion (hereinafter, also referred to as a functional portion) in which the first pattern portions and the second pattern portions are arranged is likely to be formed stably. Therefore, in the optical modulator, the functional portion can stably modulate light. In addition, in the optical modulator, since the first extension portions and the second extension portions are provided, occurrence of dielectric breakdown due to abnormal electric field concentration in the modulation layer can be suppressed. This also makes it possible to stably modulate light. As described above, according to the optical modulator, light can be stably modulated.

The optical modulator according to the aspect of the present disclosure may be [2] “The optical modulator according to [1], wherein a length of each of the plurality of first extension portions and a length of each of the plurality of second extension portions are equal to or greater than an arrangement period of the plurality of first pattern portions and the plurality of second pattern portions”. In this case, the functional portion can be more stably formed, and occurrence of dielectric breakdown due to abnormal electric field concentration in the modulation layer can be further suppressed.

The optical modulator according to the aspect of the present disclosure may be [3] “The optical modulator according to [1] or [2], wherein a length of each of the plurality of first extension portions is shorter than a length of each of the plurality of first pattern portions, and a length of each of the plurality of second extension portions is shorter than a length of each of the plurality of second pattern portions”. In this case, the lengths of the first pattern portions and the second pattern portions can be secured, and the size of the functional portion can be secured.

The optical modulator according to the aspect of the present disclosure may be [4] “The optical modulator according to any one of [1] to [3], wherein an interval between the plurality of first pattern portions and the plurality of second extension portions in the first direction, and an interval between the plurality of second pattern portions and the plurality of first extension portions in the first direction are two or less times an arrangement period of the plurality of first pattern portions and the plurality of second pattern portions”. In this case, it is possible to suppress occurrence of a difference in an opening density depending on a position in the conductive portion, and it is possible to stably form the pattern structure portion.

The optical modulator according to the aspect of the present disclosure may be [5] “The optical modulator according to any one of [1] to [4], wherein an interval between the first electrode portion and the second electrode portion is two or less times an arrangement period of the plurality of first pattern portions and the plurality of second pattern portions at any position”. In this case, it is possible to further suppress occurrence of a difference in the opening density depending on a position in the conductive portion, and it is possible to further stably form the pattern structure portion.

The optical modulator according to the aspect of the present disclosure may be [6] “The optical modulator according to any one of [1] to [5], further including: a reflection layer formed on the modulation layer”. In this case, the optical modulator can be configured in a reflection type. The optical modulator according to the aspect of the present

disclosure may be [7] “The optical modulator according to any one of [1] to [6], wherein an arrangement period of the plurality of first pattern portions and the plurality of second pattern portions is 0.5 μm or more and 15 μm or less”. The arrangement period of the first pattern portions and the second pattern portions is set, for example, to less than a wavelength of target light. In the optical modulator of [7], it is possible to modulate light with a wavelength corresponding to the arrangement period.

The optical modulator according to the aspect of the present disclosure may be [8] “The optical modulator according to any one of [1] to [7], wherein a plurality of the conductive portions are one-dimensionally or two-dimensionally arranged on the substrate”. In this case, it is possible to realize phase modulation by one-dimensional or two-dimensional modulation pattern by using a region corresponding to the one-dimensionally or two-dimensionally arranged conductive portions as a modulation cell (modulation pixel).

A method for manufacturing an optical modulator according to another aspect of the present disclosure is [9] “A method for manufacturing the optical modulator according to any one of [1] to [8], the method sequentially including: a process of disposing a resist layer on a layer corresponding to the conductive portion; a process of transferring a pattern shape to the resist layer by using a mold having at least the pattern shape corresponding to the plurality of first pattern portions, the plurality of second pattern portions, the plurality of first extension portions, and the plurality of second extension portions; a process of etching the layer corresponding to the conductive portion by using the resist layer as a mask to form the conductive portion; and a process of forming the modulation layer on the substrate to cover at least the pattern structure portion of the conductive portion”.

In the method for manufacturing an optical modulator, the conductive portion is formed by transferring a pattern shape by using a mold having at least the pattern shape corresponding to the first pattern portion, the second pattern portions, the first extension portions, and the second extension portion. That is, the conductive portion is formed by imprint lithography. Since the first extension portions and the second extension portions are provided as described above, it is possible to secure an interval between the first pattern portions and the second base portion, and an interval between the second pattern portions and the first base portion. When the intervals are secured, for example, even when forming the pattern structure portion by using imprint lithography, a portion (a functional portion) in which the first pattern portions and the second pattern portions are arranged is likely to be formed stably. Therefore, in the method for manufacturing an optical modulator, it is possible to obtain an optical modulator capable of stably modulating light. In addition, since the first extension portions and the second extension portions are provided, it is possible to suppress occurrence of a difference in the opening density depending on a position in the conductive portion. That is, for example, in a case of lengthening the intervals simply without providing the first extension portions and the second extension portions, there is a possibility that at a position corresponding to the interval, an opening (region where the conductive portion is not formed) may be wider, for example, as compared with a position corresponding to the function portion. In this case, there is a concern that a difference occurs in a residual film thickness of the resist layer due to a difference in the opening density depending on the position, and the pattern structure portion may not be formed stably. In this regard, in the method for manufacturing an optical modulator, since the first extension portions and the second extension portions are provided, it is possible to suppress occurrence of an opening density difference in the conductive portion, and as a result, it is possible to stably form the pattern structure portion. As described above, according to the method for manufacturing an optical modulator, it is possible to manufacture an optical modulator capable of stably modulating light.

A method for manufacturing an optical modulator according to still another aspect of the present disclosure is [10] “A method for manufacturing the optical modulator according to [8], the method sequentially including: a process of disposing a resist layer on a layer corresponding to the plurality of conductive portions; a process of transferring a pattern shape to the resist layer by using a mold having at least the pattern shape corresponding to the plurality of first pattern portions, the plurality of second pattern portions, the plurality of first extension portions, the plurality of second extension portions, and a separation groove that separates the plurality of conductive portions from each other; a process of etching the layer corresponding to the plurality of conductive portions by using the resist layer as a mask to form the plurality of conductive portions; and a process of forming the modulation layer on the substrate to cover the pattern structure portion of the plurality of conductive portions”. In this case, the separation groove can be formed by imprint lithography, and the manufacturing processes can be simplified. A method for manufacturing an optical modulator according to

still another aspect of the present disclosure is “A method for manufacturing an optical modulator including a substrate, a conductive portion that includes a pattern structure portion having a periodic arrangement and is formed on the substrate, the pattern structure portion including a plurality of first pattern portions extending in a first direction orthogonal to a thickness direction of the substrate and a plurality of second pattern portions extending in the first direction and arranged alternately with the plurality of first pattern portions in a second direction orthogonal to the thickness direction of the substrate and the first direction, and a modulation layer that is formed by an electro-optic polymer and is formed on the substrate to cover at least the pattern structure portion, the method sequentially including: a process of disposing a resist layer on a layer corresponding to the conductive portion; a process of transferring a pattern shape to the resist layer by using a mold having at least the pattern shape corresponding to the plurality of first pattern portions and the plurality of second pattern portion; a process of etching the layer corresponding to the conductive portion by using the resist layer as a mask to form the conductive portion; and a process of forming a modulation layer on the substrate to cover at least the pattern structure portion of the conductive portion”.

In the method for manufacturing an optical modulator, the conductive portion is formed by transferring a pattern shape by using a mold having at least the pattern shape corresponding to the first pattern portions and the second pattern portions. That is, the conductive portion is formed by imprint lithography. According to this, for example, it is possible to shorten time for the manufacturing processes, and it is possible to realize a reduction in the cost and power consumption. In addition, it is possible to process a large area and a curved surface.

According to the aspects of the present disclosure, it is possible to provide an optical modulator capable of stably modulating light, and a method for manufacturing the optical modulator.

### BRIEF DESCRIPTION OF THE DRAWINGS

FIG. 1 is a configuration diagram of an optical modulation device including an optical modulator of an embodiment.

FIG. 2 is a cross-sectional view of the optical modulator along line II-II in FIG. 1.

FIG. 3 is a cross-sectional view of the optical modulator along line III-III in FIG. 1.

FIG. 4 is a view illustrating a conductive portion of the optical modulator of the embodiment.

FIG. 5 is a view illustrating an example in which conductive portions are two-dimensionally arranged.

FIGS. 6A, 6B, and 6C are views illustrating a method for manufacturing the optical modulator.

FIGS. 7A, 7B, 7C, and 7D are views illustrating the method for manufacturing the optical modulator.

FIGS. 8A, 8B, and 8C are views illustrating the method for manufacturing the optical modulator.

FIGS. 9A, 9B, and 9C are views illustrating the method for manufacturing the optical modulator.

FIGS. 10A, 10B, and 10C are views illustrating the method for manufacturing the optical modulator.

FIGS. 11A, 11B, and 11C are views illustrating the method for manufacturing the optical modulator.

FIGS. 12A, 12B, and 12C are views illustrating the method for manufacturing the optical modulator.

FIGS. 13A, 13B, and 13C are views illustrating a method for manufacturing an optical modulator according to a modification example.

FIGS. 14A, 14B, and 14C are views illustrating the method for manufacturing the optical modulator according to the modification example.

FIG. 15 is a view illustrating a conductive portion of an optical modulator of a first reference example.

FIG. 16A is a photograph showing a formation example of an end portion of a pattern portion, and FIG. 16B is a photograph showing a formation example of a central portion of the pattern portion.

FIG. 17 is a view illustrating a conductive portion of an optical modulator of a second reference example.

FIGS. 18A and 18B are views illustrating a relationship between an opening density and a resist resin amount in a pattern structure portion.

FIGS. 19A and 19B are photographs illustrating a relationship between the opening density and a residual film thickness of a resist layer in the pattern structure portion.

### DETAILED DESCRIPTION

Hereinafter, an embodiment of the present disclosure will be described in detail with reference to the accompanying drawings. In the following description, the same reference numeral will be given to the same or equivalent element, and redundant description will be omitted.

Hereinafter, description will be given on the assumption that a thickness direction of an optical modulator 2 (a thickness direction of a substrate 10 constituting an optical modulator 2) is a Z-direction, a direction orthogonal to the Z-direction is an X-direction (a second direction), and a direction orthogonal to the Z-direction and the X-direction is a Y-direction (a first direction).

### Optical Modulation Device

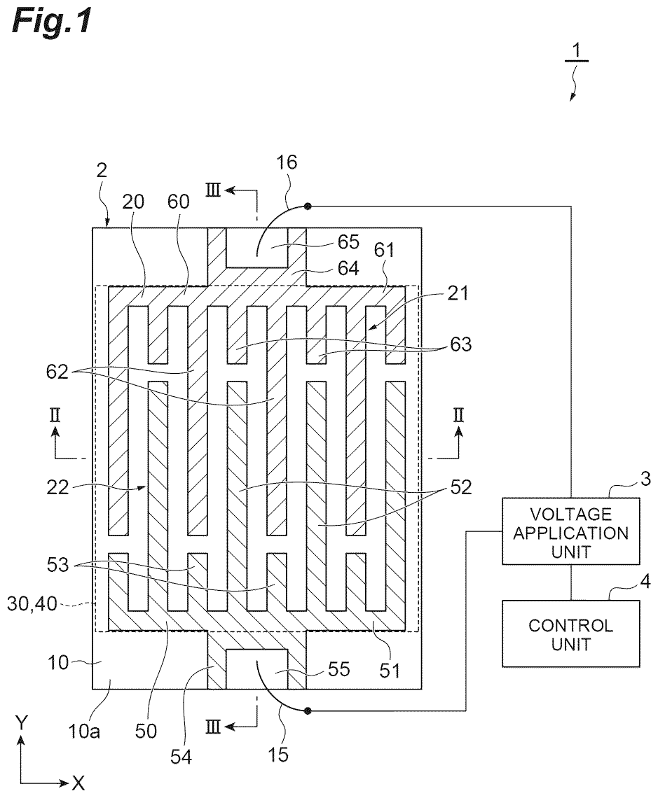

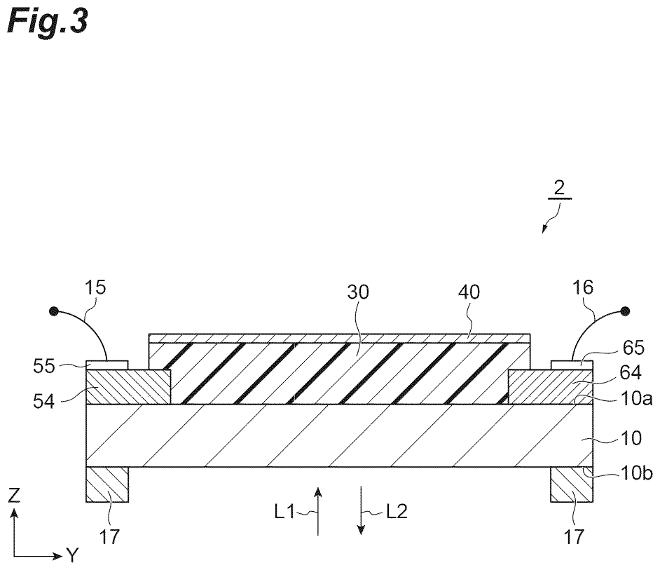

As illustrated in FIG. 1, an optical modulation device 1 includes the optical modulator 2. As illustrated in FIG. 1 to FIG. 3, the optical modulator 2 includes the substrate 10, a conductive portion 20, a modulation layer 30, and a reflection layer 40. In FIG. 1, a region where the modulation layer 30 and the reflection layer 40 are provided is indicated by a broken line. The optical modulator 2 modulates a phase of target light L1 (modulation target light) that is incident as a modulation target, and emits the target light L1 to the outside as modulated light L2.

The substrate 10 (base layer) is formed by, for example, an insulating material having a transmitting property with respect to target light L1. In this example, a lower surface 10b of the substrate 10 is set as an incident surface to which the target light L1 is incident. As the insulating material constituting the substrate 10, for example, a dielectric material having a refractive index lower than that of a conductive material constituting the conductive portion 20, and having a transmitting property with respect to the target light L1 may be employed. In this example, the substrate 10 is formed by quartz (SiO₂) glass, but, may be formed by a dielectric material such as TiO₂, AL₂O₃, Nb₂O₅, MgF₂, and Ta₂O₅ or the like.

The conductive portion 20 is formed by a conductive material in a layer shape. The conductive portion 20 includes a pattern structure portion 21 having a periodic arrangement, and is formed on an upper surface 10a of the substrate 10. The conductive portion 20 can be used to apply an electric field (to apply a voltage) to the modulation layer 30. The conductive material constituting the conductive portion 20 is preferably a semiconductor material, and examples thereof include Si. Examples of the conductive material of the conductive portion 20 which can be used include single element semiconductor materials such as Si and Ge, group III-V compound semiconductor materials (binary mixed crystal semiconductor materials) such as GaAs, InP, InAs, GaP, AlP, GaN, and AlN, group II-VI compound semiconductor materials such as ZnS and ZnSe, group IV-IV compound semiconductor materials such as SiC and SiGe, ternary mixed crystal semiconductor materials such as InGaAs, InGaN, and AlGaN, quaternary mixed crystal semiconductor materials such as InGaAsP and GaInNAs, and transparent conductive film materials such as ITO, AZO, IZO, IGZO, GZO, ATO, NTO, and TTO. The conductive material of the conductive portion 20 may be a metal material.

The conductive portion 20 includes a first electrode portion 50 and a second electrode portion 60. The first electrode portion 50 includes a first base portion 51, a plurality of first pattern portions 52, and a plurality of first extension portions 53. The second electrode portion 60 includes a second base portion 61, a plurality of second pattern portions 62, and a plurality of second extension portions 63. In this example, each of the portions is constituted by a rectangular (strip-shaped) portion extending along a certain direction.

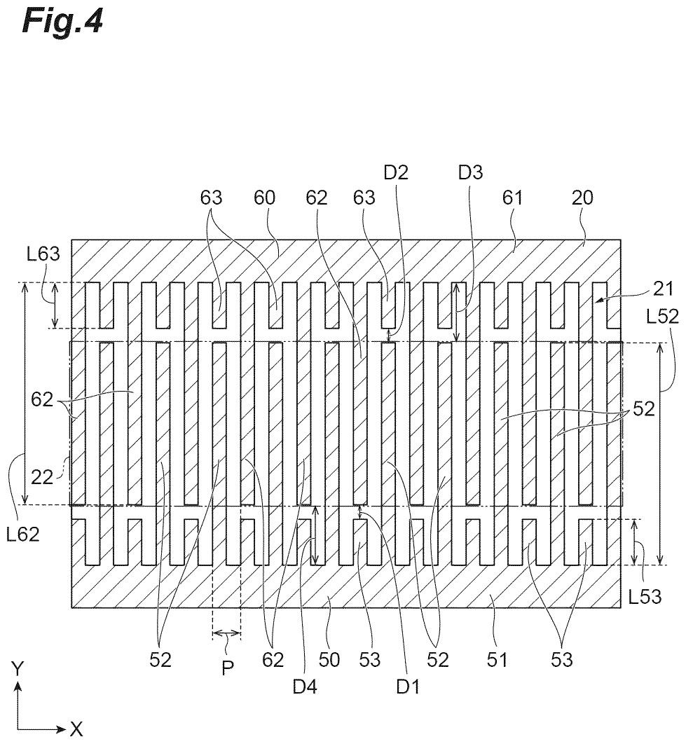

The first base portion 51 extends straightly along the X-direction. The plurality of first pattern portions 52 and the plurality of first extension portions 53 extend straightly from the first base portion 51 toward one side (a second base portion 61 side) in the Y-direction. The first pattern portions 52 and the first extension portions 53 are alternately arranged at equal intervals in the X-direction. A length L53 (a length in the Y-direction) of the first extension portions 53 is shorter than a length L52 (a length in the Y-direction) of the first pattern portions 52 (FIG. 4). That is, the first pattern portions 52 and the first extension portions 53 are formed in a comb shape, the first pattern portions 52 constitute long comb teeth and the first extension portions 53 form short comb teeth. The first base portion 51, the first pattern portions 52, and the first extension portions 53 have the same width (a length in the X-direction) in this example. Note that, although the first pattern portions 52 and first extension portions 53 are shown in a simplified manner in FIG. 1. However, actually, a large number of first pattern portions 52 and first extension portions 53 are formed to constitute a fine structure. This is also true of the second pattern portions 62 and the second extension portions 63.

The second base portion 61 extends straightly along the X-direction. The second base portion 61 extends in parallel to the first base portion 51, and faces the first base portion 51 in the Y-direction. The plurality of second pattern portions 62 and the plurality of second extension portions 63 extend straightly from the second base portion 61 toward the other side (a first base portion 51 side) in the Y-direction. The second pattern portions 62 and the second extension portions 63 are alternately arranged at equal intervals in the X-direction. A length L63 (a length in the Y-direction) of the second extension portions 63 is shorter than a length L62 (a length in the Y-direction) of the second pattern portions 62 (FIG. 4). That is, the second pattern portions 62 and the second extension portions 63 are formed in a comb shape, the second pattern portions 62 constitute long comb teeth, and the second extension portions 63 constitute short comb teeth. In this example, the second base portion 61, the second pattern portions 62, and the second extension portions 63 have the same width (a length in the X-direction). In this example, widths of the second base portion 61, the second pattern portions 62, and the second extension portions 63 are the same as the widths of the first base portion 51, the first pattern portions 52, and the first extension portions 53.

The plurality of second pattern portions 62 are arranged alternately with the plurality of first pattern portions 52 at equal intervals in the X-direction. A portion (hereinafter, also referred to as a functional portion 22) where the first pattern portions 52 and the second pattern portions 62 are arranged is configured in a grating shape and functions as a modulation region that modulates a phase of the target light L1. In the conductive portion 20, the plurality of first extension portions 53 extend from the first base portion 51 toward the second pattern portion 62. That is, the first extension portions 53 and the second pattern portions 62 are located on the same straight lines parallel to the Y-direction. The plurality of second extension portions 63 extend from the second base portion 61 toward the first pattern portions 52. That is, the second extension portions 63 and the first pattern portions 52 are located on the same straight lines parallel to the Y-direction. The first pattern portions 52, the first extension portions 53, the second pattern portions 62, and the second extension portions 63 constitute a pattern structure portion 21 having a periodic arrangement.

The first electrode portion 50 further includes a wire connection portion 54 formed on a side opposite to the first pattern portions 52 with respect to the first base portion 51 (the other side in the Y-direction). The wire connection portion 54 is continuous with the first base portion 51. A first pad portion 55 is formed on the wire connection portion 54, and a wire 15 is connected to the first pad portion 55. The second electrode portion 60 further includes a wire connection portion 64 formed on a side opposite to the second pattern portions 62 with respect to the second base portion 61 (one side in the Y-direction). The wire connection portion 64 is continuous with the second base portion 61. A second pad portion 65 is formed on the wire connection portion 64, and a wire 16 is connected to the second pad portion 65. For example, the first pad portion 56 and the second pad portion 65 are formed by a metal material such as Cr/Au. A first voltage is applied to the first electrode portion 50 via the wire 15 and the first pad portion 55. A second voltage different from the first voltage is applied to the second electrode portion 60 via the wire 16 and the second pad portion 65.

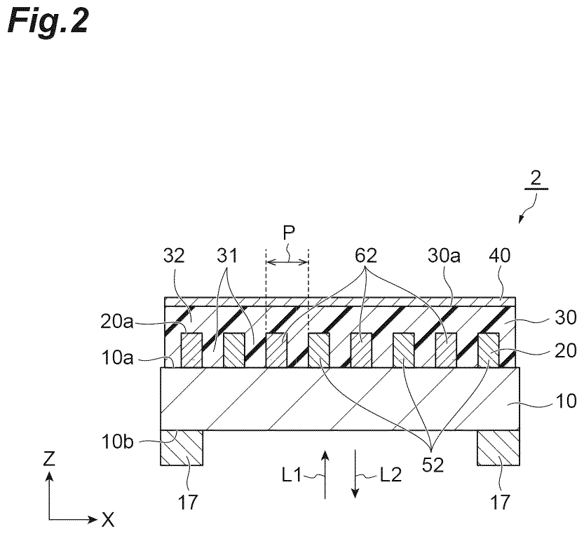

The modulation layer 30 is an EO polymer layer formed by an Electro-Optic (EO) polymer, and is formed so as to cover the substrate 10 and the pattern structure portion 21 of the conductive portion 20. Specifically, as shown in FIG. 2, the modulation layer 30 includes a filling portion 31 that fills a space between the first electrode portion 50 and the second electrode portion 60, and a spacer portion 32 formed with a predetermined thickness on the upper surface 20a of the conductive portion 20.

In the modulation layer 30, particularly, in the filling portion 31 located in the functional portion 22 in which the first pattern portions 52 and the second pattern portion 62 are arranged, a refractive index of the EO polymer varies due to application of an electric field (application of a voltage) using the conductive portion 20. In the optical modulator 2, a phase of the target light L1 is modulated by using the variation of the refractive index in the modulation layer 30.

The EO polymer constituting the modulation layer 30 has an internal polarization structure. The internal polarization structure of the EO polymer can be obtained, for example, by dispersing EO dye molecules in the polymer, and the internal polarization structure of the EO dye molecules, and the like can be oriented along the electric field by applying a high electric field to the EO polymer at a high temperature (poling treatment).

In the poling treatment, an electric field is applied by using the first electrode portion 50 and the second electrode portion 60 of the conductive portion 20 while heating the EO polymer to a temperature equal to or higher than a glass transition temperature, thereby orienting molecules having the internal polarization structure of the EO dye molecules and the like inside the EO polymer along the electric field. The EO polymer is then returned to room temperature, thereby fixing the orientation state of the internal polarization structure. By carrying out the treatment, the EO dye molecules are fixed in a strongly polarized or oriented state within the EO polymer.

In the example in FIG. 1, in the conductive portion 20, the first pattern portions 52 and the second pattern portions 62 are alternately arranged in the X-direction. In this case, in the filling portion 31 of the modulation layer 30, the EO polymer is alternately polarized or oriented on one side and the other side in the X-direction. In this state, by applying an electric field to the EO polymer of the modulation layer 30 by using the conductive portion 20 along a polarization or orientation direction of the internal polarization structure, a refractive index of the EO polymer can be changed in correspondence with the intensity of the applied electric field (applied voltage) by the electro-optic effect.

In the optical modulator 2, the phase of the target light L1 incident from the lower surface 10b of the substrate 10 is modulated by controlling a variation of the refractive index in the modulation layer 30. The phase of the target light L1 is modulated when passing through the modulation layer 30 of which the refractive index is controlled by application of the electric field by using the conductive portion 20, and the target light L1 is reflected by the reflection layer 40 formed on an upper portion of the modulation layer 30, and is emitted as the modulated light L2 from the lower surface 10b of the substrate 10.

The reflection layer 40 is formed on an upper surface 30a of the modulation layer 30. For example, the reflection layer 40 is formed by a metal material such as gold (Au). A material of the reflection layer 40 may be, for example, a metal material such as aluminum (Al), silver (Ag), platinum (Pt), titanium (Ti), and chromium (Cr). The reflection layer 40 may not be a metal layer, and may be, for example, a dielectric multilayer film.

The reflection layer 40 reflects the target light L1, which is incident from the lower surface 10b of the substrate 10 and passes through the modulation layer 30 of the EO polymer, toward the substrate 10. The optical modulator 2 is configured as a reflection-type optical modulator that emits the target light L1, which has been phase-modulated after passing through the modulation layer 30 and reflected by the reflection layer 40, as the modulated light L2 to the outside from the lower surface 10b of the substrate 10. The optical modulator 2 is disposed on a mount 17 having an opening or incident window through which the target light L1 and the modulated light L2 pass. The mount 17 may be omitted.

As illustrated in FIG. 1, the optical modulation device 1 further includes a voltage application unit 3 and a control unit 4 in addition to the optical modulator 2. One terminal of the voltage application unit 3 is electrically connected to the first electrode portion 50 via a wire 15, and the other terminal is electrically connected to the second electrode portion 60 via a wire 16. According to this, first and second voltages are applicable from the voltage application unit 3 to the first electrode portion 50 and the second electrode portion 60, respectively.

The control unit 4 controls a phase modulation operation of the target light L1 in the optical modulator 2 by controlling a voltage application operation (electric field application operation) to the optical modulator 2 by the voltage application unit 3. For example, a power supply device can be used as the voltage application unit 3. For example, a computer including a CPU, a storage unit, a display unit, an input unit, and the like can be used as the control unit 4.

In the optical modulator 2, an arrangement period P (FIG. 2) of the first pattern portions 52 and the second pattern portions 62 in the conductive portion 20 is set to, for example, less than a wavelength of the target light L1. The arrangement period P is, for example, 0.5 μm or more and 15 μm or less. When using a sub-wavelength structure (meta-surface structure) in which the arrangement period P is set to less than the wavelength of the target light L1 in this manner, it is possible to suppress generation of high-order diffracted light, and it is possible to appropriately realize phase modulation of the target light L1 using the modulation layer 30 of the EO polymer. In addition, in a configuration using the sub-wavelength structure, it is possible to miniaturize and integrate a modulation cell, and it is also possible to reduce a size of the modulation pixel as compared with a liquid crystal on silicon (LCOS)-type spatial light modulator (SLM) that uses a liquid crystal layer.

The conductive portion 20 of the optical modulator 2 will be further described with reference to FIG. 4. In FIG. 4, the functional portion 22 is indicated by a two-dotted chain line. Wire connection portions 54 and 64 and the like are not illustrated in the drawing. The length L53 of the first extension portions 53 and the length L63 of the second extension portions 63 of the first electrode portion 50 are equal to or greater than the arrangement period P of the first pattern portions 52 and the second pattern portions 62. In this example, the lengths L53 and L63 are equal to each other. For example, when the arrangement period P is approximately 700 nm to 800 nm, the lengths L53 and L63 are approximately several μm to 25 μm. The lengths L53 and L63 may be 1.5 μm or more. The lengths L53 and L63 may be equal to or greater than the wavelength of the target light L1.

An interval between the first electrode portion 50 and the second electrode portion 60 is two or less times the arrangement period P of the first pattern portions 52 and the second pattern portions 62 at any position. Specifically, an interval D1 between the first pattern portions 52 and the second extension portions 63 in the Y-direction and an interval D2 between the second pattern portions 62 and the first extension portions 53 in the Y-direction are two or less times the arrangement period P. In addition, an interval between the first pattern portions 52 and the second extension portions 63 in the X-direction and an interval between the second pattern portions 62 and the first extension portions 53 in the X-direction are also two or less times the arrangement period P. According to this, the interval between the first electrode portion 50 and the second electrode portion 60 is two or less times the arrangement period P at any position. For example, in a case where the arrangement period P is approximately 700 nm to 800 nm, the interval between the first electrode portion 50 and the second electrode portion 60 is approximately several hundreds of nm. The interval between the first electrode portion 50 and the second electrode portion 60 may be 1.5 μm or less. The interval between the first electrode portion 50 and the second electrode portion 60 may be one or less times the arrangement period P, or may be three or less times the arrangement period P. The interval between the first electrode portion 50 and the second electrode portion 60 may be less than the wavelength of the target light L1. In addition, when the interval is two or less times the arrangement period P, the interval D1 between the first pattern portions 52 and the second extension portions 63 in the Y-direction and the interval D2 between the second pattern portions 62 and the first extension portions 53 in the Y-direction (distance in the Y-direction), and the interval between the first pattern portions 52 and the second extension portions 63 in the X-direction and the interval between the second pattern portions 62 and the first extension portions 53 in the X-direction (distance in the X-direction) may be equal to each other or may not be equal to each other.

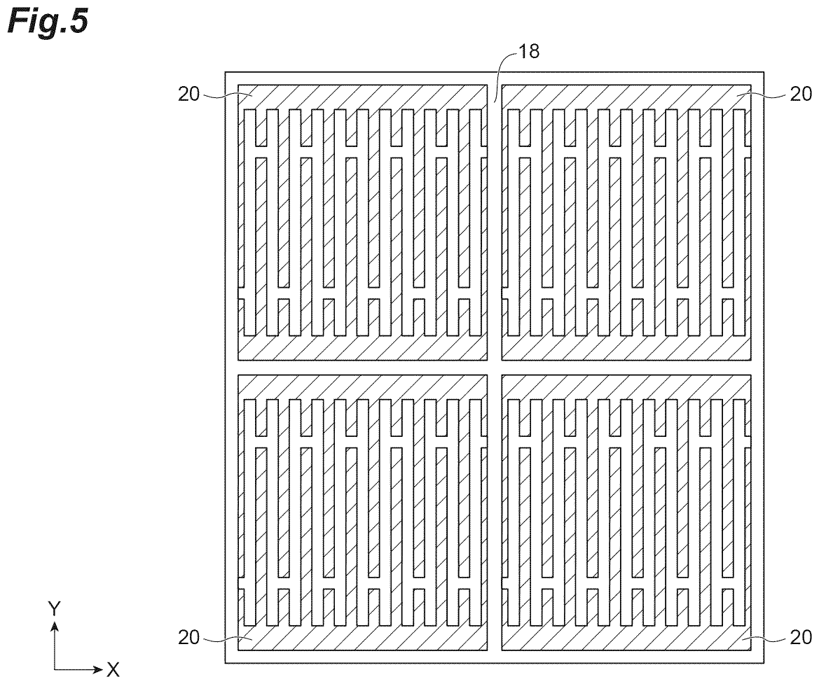

As illustrated in FIG. 5, the conductive portion 20 may be arranged two-dimensionally. In the optical modulator 2 of FIG. 5, a plurality of the conductive portions 20 are formed on the one substrate 10. In this example, four conductive portions 20 are arranged in a lattice shape with two rows and two columns. In this case, regions corresponding to the two-dimensionally arranged conductive portions 20 are used as modulation cells (modulation pixels), and phase modulation by a two-dimensional modulation pattern can be realized. In the optical modulator 2 of FIG. 5, a separation groove 18 for electrically and physically separating the conductive portions 20 adjacent to each other is formed between the adjacent conductive portions 20. The separation groove 18 is a groove portion formed in the substrate 10. Note that, although the conductive portions 20 are arranged two-dimensionally in this example, the conductive portions 20 may be arranged one-dimensionally (in one column).

### [Method for Manufacturing Optical Modulator]

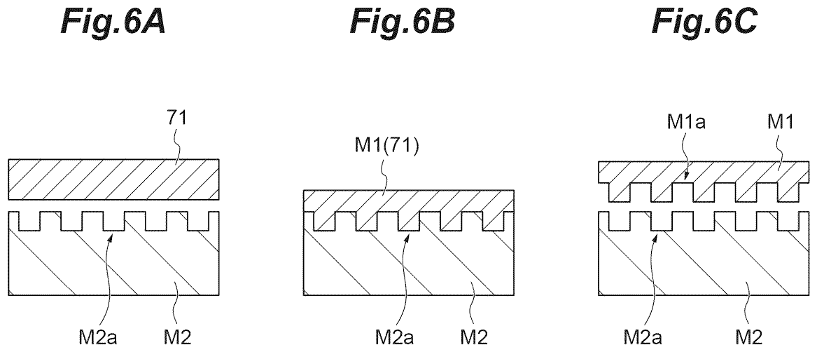

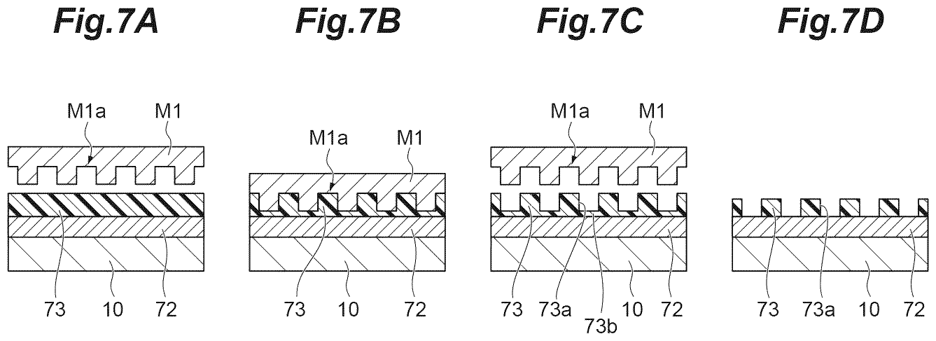

A method for manufacturing the optical modulator 2 will be described with reference to FIG. 6A to FIG. 11C. In the method for manufacturing the optical modulator 2, a working mold having a predetermined pattern shape is used to transfer the pattern shape so as to form the conductive portion 20. That is, the conductive portion 20 is formed by nanoimprint lithography. First, the nanoimprint lithography will be described with reference to FIG. 6A to FIG. 7C. The nanoimprint lithography includes a working mold forming process illustrated in FIGS. 6A to 6C and a transfer process illustrated in FIGS. 7A to 7C.

As illustrated in FIGS. 6A to 6C, in the working mold forming process, a working mold M1 having a predetermined pattern shape M1a is formed. The working mold M1 is formed by using a master mold M2 having a pattern shape M2a corresponding to the pattern shape M1a. The pattern shape M2a is an inverted shape of the pattern shape M1a. The master mold M2 is formed by, for example, a semiconductor material such as Si or GaAs, or a glass material such as quartz (SiO₂). The working mold M1 is formed by, for example, a resin material such as a polymer resin. When performing the transfer process to an imprint layer by using the working mold M1 instead of the master mold M2, damage to the master mold M2 can be suppressed, and the optical modulator 2 can be stably manufactured. In addition, since the working mold M1 is formed by, for example, a polymer resin and has higher trackability as compared with the master mold M2, it is easy to follow the substrate 10 during transfer, and this also makes it possible to stably manufacture the optical modulator 2.

In the working mold forming process, first, a resin material 71, which will become the working mold M1 after processing, is disposed on the master mold M2 (FIG. 6A). At this time, the resin material 71 is disposed on the pattern shape M2a of the master mold M2. Next, while the resin material 71 is pressed against the master mold M2, the resin material 71 is cured by heating, ultraviolet irradiation, or the like. (FIG. 6B). According to this, the pattern shape M1a corresponding to the pattern shape M2a is formed in the resin material 71, and the resin material 71 becomes the working mold M1. Next, the working mold M1 is released from the master mold M2 (FIG. 6C). The working mold M1 is obtained by the above-described process.

In the transfer process, first, a resist layer 73 is disposed on a layer 72 (a layer corresponding to the conductive portion 20) that will become the conductive portion 20 after processing (FIG. 7A). The layer 72 is formed by, for example, Si. The resist layer 73 is formed by, for example, an ultraviolet curable resin, a thermosetting resin, or the like. Next, the resist layer 73 is cured by heating, ultraviolet irradiation, or the like in a state in which the working mold M1 is pressed against the resist layer 73 (FIG. 7B). According to this, the pattern shape M1a is transferred to the resist layer 73. Next, the working mold M1 is released from the resist layer 73 (FIG. 7C). Next, a residual film 73b in an opening 73a formed in the resist layer 73 in correspondence with the pattern shape M1a is removed (FIG. 7D). The residual film 73b is the resist layer 73 remained on a bottom surface of the opening 73a. When the residual film 73b remains, etching in the next process cannot be performed well, and thus the residual film 73b is removed. The residual film 73b is removed by, for example, dry etching. Then, the layer 72 is etched by using the resist layer 73 as a mask to form the conductive portion 20 (not illustrated). The conductive portion 20 is formed by the above-described process.

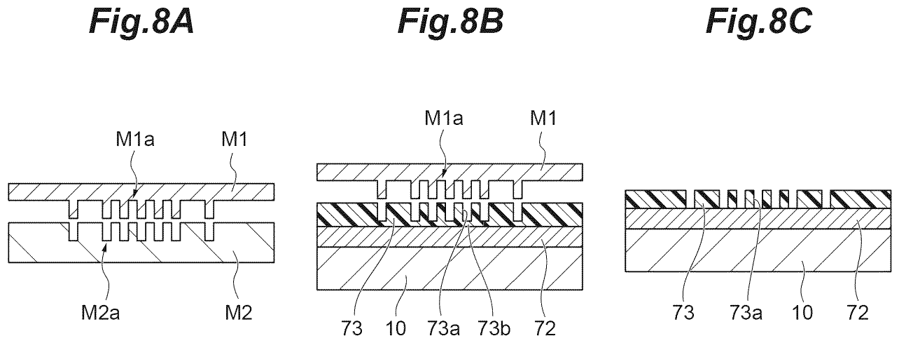

The method for manufacturing the optical modulator 2 will be described with reference to FIG. 8A to FIG. 11C. In this example, a method for manufacturing the optical modulator 2 in which the above-described conductive portions 20 are arranged two-dimensionally will be described with reference to FIG. 5, but as will be described later, an optical modulator 2 including only one conductive portion 20 can also be manufactured in the same manner. Note that, each configuration is shown in a simplified manner in FIG. 8A to FIG. 11C.

In the method for manufacturing the optical modulator 2, first, as illustrated in FIG. 8A, a working mold M1 is formed by using a master mold M2 by a process similar to the working mold forming process described with reference to FIGS. 6A to 6C. A pattern shape M1a of the working mold M1 and a pattern shape M2a of the master mold M2 include pattern shapes corresponding to the first pattern portions 52, the first extension portions 53, the second pattern portions 62, and the second extension portions 63 (pattern structure portion 21) of the conductive portion 20. The pattern shape M1a of the working mold M1 is an inverted shape of the portions. As described above, the pattern shape M2a of the master mold M2 is an inverted shape of the pattern shape M1a of the working mold M1. Therefore, the pattern shape M2a of the master mold M2 is approximately the same shape as that of the first pattern portions 52, the first extension portions 53, the second pattern portions 62, and the second extension portions 63 of the conductive portion 20. Note that, the pattern shape M2a of the master mold M2 may be formed slightly larger than the shape of an object to be formed in consideration of cure shrinkage and the like.

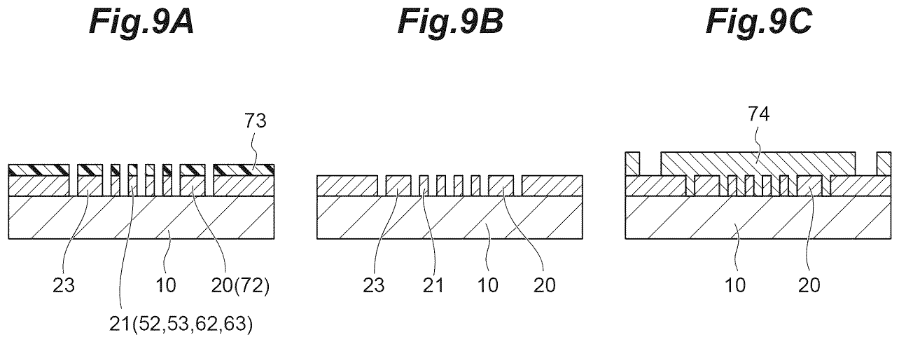

Next, the conductive portion 20 is formed by nanoimprint lithography using the working mold M1 (FIGS. 8B to 9B). More specifically, first, a resist layer 73 is disposed on a layer (layer corresponding to the conductive portion 20) 72 that will become the conductive portion 20 after processing (FIG. 8B). The layer 72 is disposed on the substrate 10 before a process of disposing the resist layer 73. Next, the resist layer 73 is cured in a state in which the working mold M1 is pressed against the resist layer 73, thereby transferring the pattern shape M1a to the resist layer 73 (FIG. 8B). After the transfer, the working mold M1 is released from the resist layer 73 (FIG. 8B).

Next, a residual film 73b in an opening 73a formed in the resist layer 73 is removed (FIG. 8C). Next, the layer 72 is etched by using the resist layer 73 as a mask to form the conductive portion 20 (FIG. 9A). In this process, the pattern shape M1a transferred from the working mold M1 to the resist layer 73 is further transferred from the resist layer 73 to the layer 72, and as a result, the conductive portion 20 is formed. In the example of FIG. 9A, the first pattern portions 52, the first extension portions 53, the second pattern portions 62, and the second extension portions 63 (pattern structure portion 21) are formed in the conductive portion 20, and the other structure portion 23 is also formed. In this way, the pattern shape M1a of the working mold M1 may include shapes other than shapes corresponding to the first pattern portions 52, the first extension portions 53, the second pattern portions 62, and the second extension portions 63. Then, the resist layer 73 is removed (FIG. 9B). Note that, the conductive portion 20 may not include the structure portion 23, and the pattern shape M1a of the working mold M1 may not include a shape corresponding to the structure portion 23.

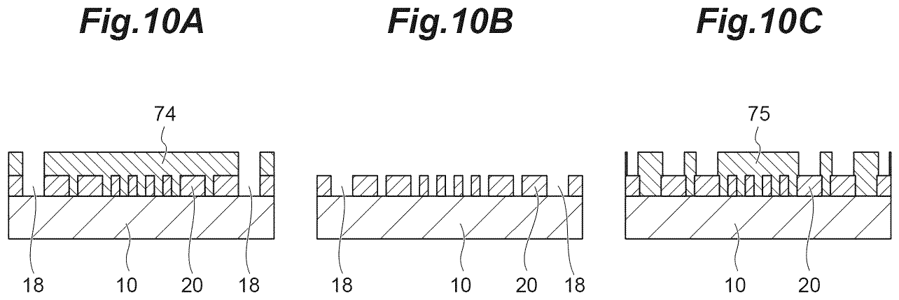

Next, the separation groove 18 (FIG. 5) that separates the conductive portions 20 from each other is formed by photolithography (FIG. 9C to 10B). More specifically, first, a photoresist layer 74 is disposed on the substrate 10 and the conductive portions 20, and the photoresist layer 74 is patterned into a predetermined shape (FIG. 9C). Next, the separation groove 18 is formed by dry etching using the photoresist layer 74 as a mask (FIG. 10A). Next, the photoresist layer 74 is removed (FIG. 10B).

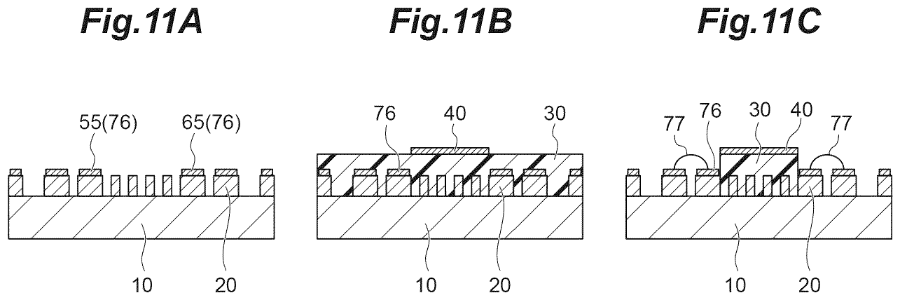

Next, a wiring electrode 76 including the first pad portion 55 and the second pad portion 65 is formed by photolithography (lift-off) (FIGS. 10C to 11A). More specifically, first, a photoresist layer 75 is disposed on the substrate 10 and the conductive portion 20, and the photoresist layer 75 is patterned into a predetermined shape (FIG. 10C). Next, the first pad portion 55 and the second pad portion 65 are formed by vapor deposition on the photoresist layer 75 and the conductive portion 20 (FIG. 11A). Next, the photoresist layer 75 is removed (FIG. 11A).

Next, the modulation layer 30 is disposed on the substrate 10 and the conductive portion 20 (FIG. 11B). This process is performed by applying an EO polymer. Next, a reflection layer 40 is formed on the modulation layer 30 by vapor deposition (FIG. 11B). Next, the EO polymer other than that on the conductive portion 20 (the EO polymer on the wiring electrode 76) is removed (FIG. 11C). According to this, the modulation layer 30 is formed on the substrate 10 so as to cover at least the pattern structure portion 21 of the conductive portion 20.

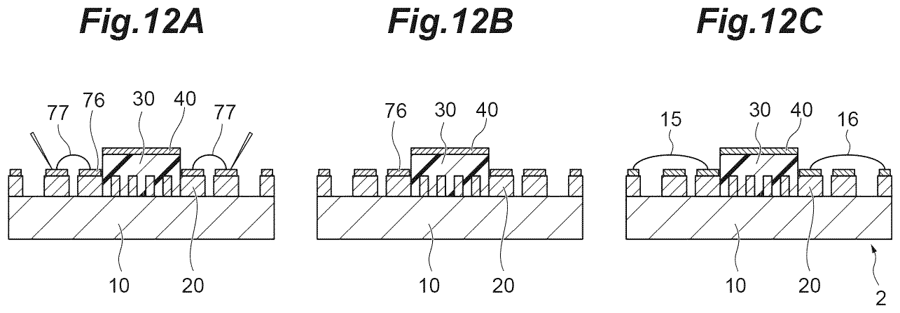

Next, a poling process is performed on the modulation layer 30 (FIG. 11C to FIG. 12B). More specifically, first, a poling wire 77 is connected to the wiring electrode 76 by wire bonding (FIG. 11C). Next, a poling process is performed in which an electric field is applied to the modulation layer 30 via the poling wire 77 and the first electrode portion 50 and the second electrode portion 60 of the conductive portion 20 (FIG. 12A). Next, the poling wire 77 is removed (FIG. 12B).

Next, the wires 15 and 16 are formed by wire bonding (FIG. 12C). Through the above-described processes, the optical modulator 2 is obtained. In the above-described example, a method for manufacturing an optical modulator 2 in which a plurality of the conductive portions 20 are arranged two-dimensionally has been described, but an optical modulator 2 having only one conductive portion 20 can also be manufactured in the same manner. In this case, the process of forming the separation groove 18 that separates the conductive portions 20 from each other is omitted.

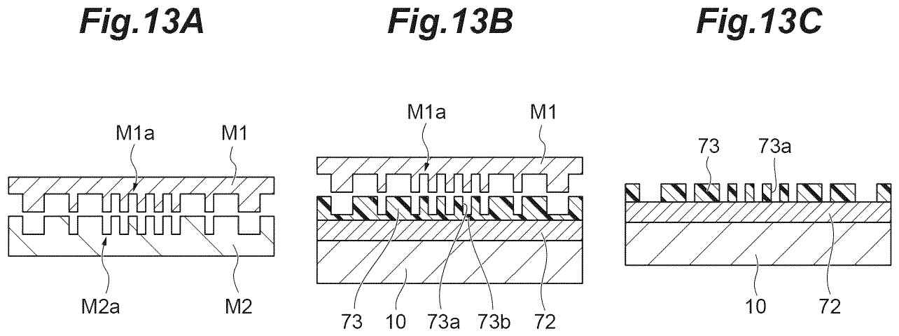

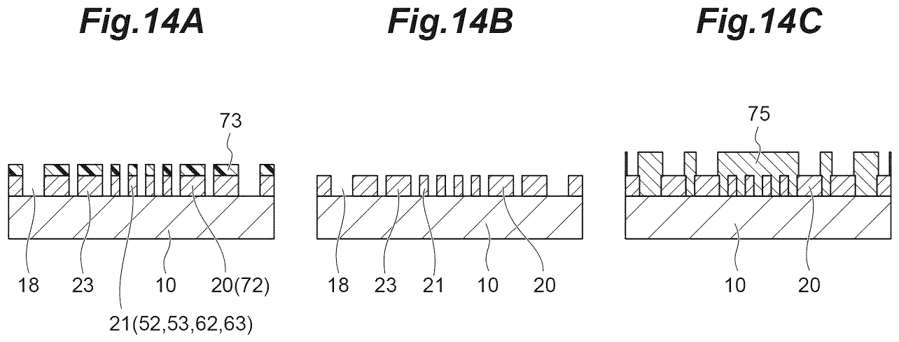

A method for manufacturing the optical modulator 2 according to a modification example will be described with reference to FIG. 13A to 14C. In the above-described example, the separation groove 18 is formed by photolithography (FIG. 9C to FIG. 10B), but in this modification example, the separation groove 18 is formed by nanoimprint lithography. In this modification example, the pattern shape M1a of the working mold M1 includes a shape corresponding to the separation groove 18 that separates the conductive portions 20 from each other in addition to the first pattern portions 52, the first extension portions 53, the second pattern portions 62, and the second extension portions 63 (pattern structure portion 21) of each of the conductive portions 20.

In the method for manufacturing the modification example, first, the conductive portion 20 is formed by nanoimprint lithography using a working mold M1 (FIG. 13A to FIG. 14B). As illustrated in FIG. 14B, in the modification example, the separation groove 18 is formed by nanoimprint lithography. Next, a wiring electrode 76 including a first pad portion 55 and a second pad portion 65 is formed by photolithography (lift-off) (FIG. 14C). Processes after forming the photoresist layer 75 are the same as the processes described above with reference to FIG. 11A to FIG. 12C, and thus description thereof will be omitted. The optical modulator 2 can also be obtained by the manufacturing method of the modification example.

### Function and Effect

In the optical modulator 2, since the modulation layer 30 is formed by an electro-optic polymer that responds at a higher speed as compared with a liquid crystal, a phase of the target light L1 can be modulated at a high speed. In addition, in the optical modulator 2, the first electrode portion 50 includes the first extension portions 53 extending from the first base portion 51 toward the second pattern portions 62 in the Y-direction (first direction), and the second electrode portion 60 includes the second extension portions 63 extending from the second base portion 61 toward the first pattern portions 52 in the Y-direction. According to this, it is possible to secure the interval between the first pattern portions 52 and the second base portion 61 and the interval between the second pattern portions 62 and the first base portion 51 as compared with a case where the first extension portions 53 and the second extension portions 63 are not provided. When the intervals are secured, even when forming the pattern structure portion 21 by using, for example, imprint lithography, the functional portion 22 in which the first pattern portions 52 and the second pattern portions 62 are arranged is likely to be formed stably. Therefore, in the optical modulator 2, the functional portion 22 can stably modulate the target light L1. In addition, in the optical modulator 2, since the first extension portions 53 and the second extension portions 63 are provided, occurrence of dielectric breakdown due to abnormal electric field concentration in the modulation layer 30 can be suppressed. That is, if the interval between the first pattern portions 52 and the second base portion 61 and the interval between the second pattern portions 62 and the first base portion 51 are short, in a case where the first base portion 51 or the second base portion 61 (pattern end portion) is poorly made, the electric field may concentrate on an edge or the like of the first base portion 51 or the second base portion 61, and thus there is a possibility that dielectric breakdown may occur. In this regard, in the optical modulator 2, since the first extension portions 53 and the second extension portions 63 are provided, the above-described intervals can be secured, and occurrence of such dielectric breakdown can be suppressed. This also makes it possible to stably modulate the target light L1. As described above, according to the optical modulator 2, the target light L1 can be stably modulated.

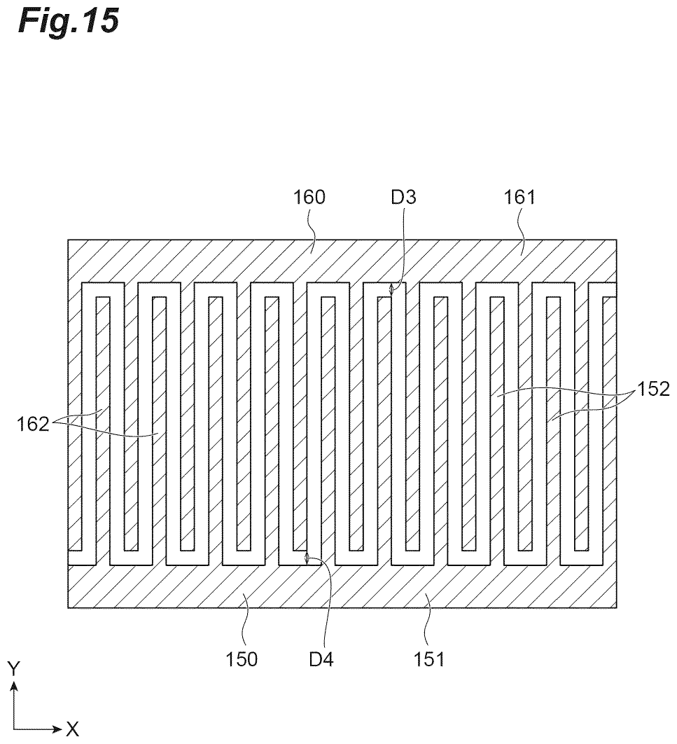

The reason why the functional portion 22 is stably formed in the optical modulator 2 will be further described. As illustrated in FIG. 4, in the optical modulator 2, the first electrode portion 50 includes the first extension portions 53, and the second electrode portion 60 includes the second extension portions 63. In contrast, in a first reference example illustrated in FIG. 15, a first electrode portion 150 includes a first base portion 151 and first pattern portions 152 but does not include the first extension portions 53, and a second electrode portion 160 includes a second base portion 161 and second pattern portions 162 but does not include the second extension portions 63. In the optical modulator 2 illustrated in FIG. 4, an interval D3 between the first pattern portions 52 and the second base portion 61 and an interval D4 between the second pattern portions 62 and the first base portion 51 can be secured as compared with the first reference example illustrated in FIG. 15 in which the first extension portions 53 and the second extension portions 63 are not provided.

An increase in the interval D3 between the first pattern portions 52 and the second base portion 61 and the interval D4 between the second pattern portions 62 and the first base portion 51 represents that the interval between the functional portion 22 in which the first pattern portions 52 and the second pattern portions 62 are arranged, and the first base portion 51 and the second base portion 61 is lengthened. When the interval between the functional portion 22 and the first base portion 51 and the second base portion 61 is lengthened, the functional portion 22 can be disposed as centrally as possible, and as a result, the functional portion 22 can be formed stably.

That is, when the pattern structure portion 21 is formed by nanoimprint lithography, at an end portion of the pattern structure portion 21, performance may be poor as compared with the central portion of the pattern structure portion 21. This is considered due to a plurality of factors such as stress concentration occurring at a structure boundary due to extrusion of a resin during nanoimprint lithography, mold release failure, and unevenness of a shape of the master mold M2.

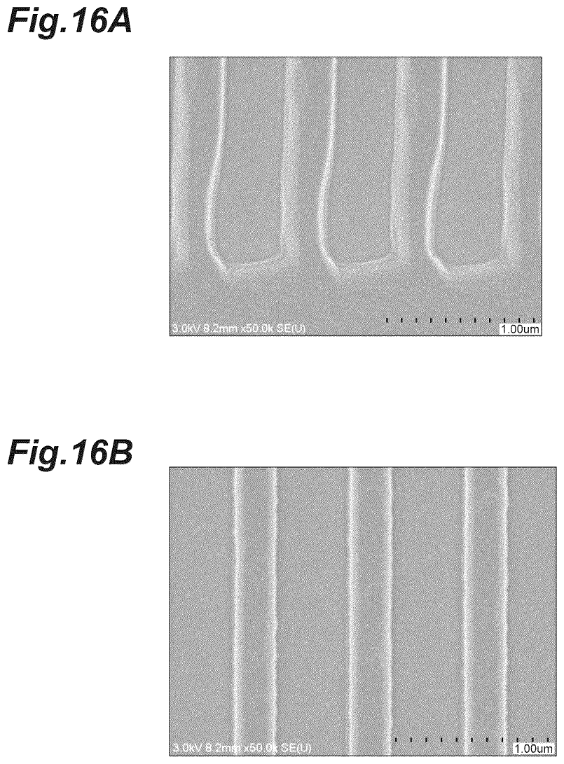

FIG. 16A and FIG. 16B are photographs showing an example of pattern portions formed by nanoimprint lithography. FIG. 16A shows an end portion of the pattern portions, and FIG. 16B shows a central portion of the pattern portions. From FIG. 16A and FIG. 16B, it can be seen that in this example, the performance of the end portion of the pattern portions is poor as compared with the central portion.

In this regard, in the optical modulator 2 of the embodiment, since the first extension portions 53 and the second extension portions 63 are provided, an interval D3 between the first pattern portions 52 and the second base portion 61, and an interval D4 between the second pattern portions 62 and the first base portion 51 (the interval between the functional portion 22 and the first base portion 51 and the second base portion 61) are secured to be long. According to this, the functional portion 22 can be disposed as centrally as possible, and as a result, the functional portion 22 can be formed stably.

In addition, in the optical modulator 2, since the first extension portions 53 and the second extension portions 63 are provided, it is possible to suppress occurrence of a difference in the opening density depending on a position in the conductive portion 20. That is, for example, when the above-described intervals D3 and D4 are lengthened by simply not providing the first extension portions 53 and the second extension portions 63 in order to stably form the functional portion 22, an opening (an area where the conductive portion 20 is not formed) becomes wider at a position corresponding to the intervals D3 and D4 as compared with, for example, a position corresponding to the functional portion 22. In this case, due to the difference in the opening density depending on the position, there is a concern that a difference in the thickness of the residual film of the resist layer 73 occurs during nanoimprint lithography, and the pattern structure portion 21 may not be stably formed. In this regard, in the optical modulator 2, since the first extension portions 53 and the second extension portions 63 are provided, it is possible to suppress occurrence of the difference in the opening density in the conductive portion 20, and as a result, it is possible to stably form the pattern structure portion 21.

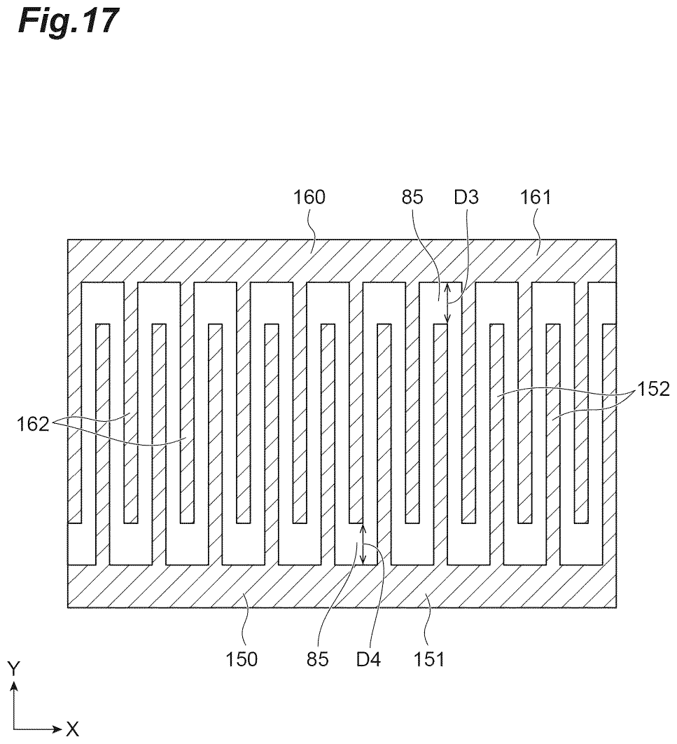

This point will be further described with reference to FIG. 17 to FIG. 19B. As illustrated in FIG. 4, in the optical modulator 2, the first electrode portion 50 includes first extension portions 53, and the second electrode portion 60 includes the second extension portions 63. In contrast, in a second reference example shown in FIG. 17, a first electrode portion 150 includes a first base portion 151 and first pattern portions 152 but does not include the first extension portions 53, and a second electrode portion 160 includes a second base portion 161 and second pattern portions 162 but does not include the second extension portions 63. In the second reference example, since the first extension portions 53 and the second extension portions 63 are not provided, the interval D3 between the first pattern portions 52 and the second base portion 61 and the interval D4 between the second pattern portions 62 and the first base portion 51 are secured to be long. As a result, in the second reference example, relatively large openings 85 are formed between the first pattern portions 52 and second base portion 61 and between second pattern portions 62 and first base portion 51.

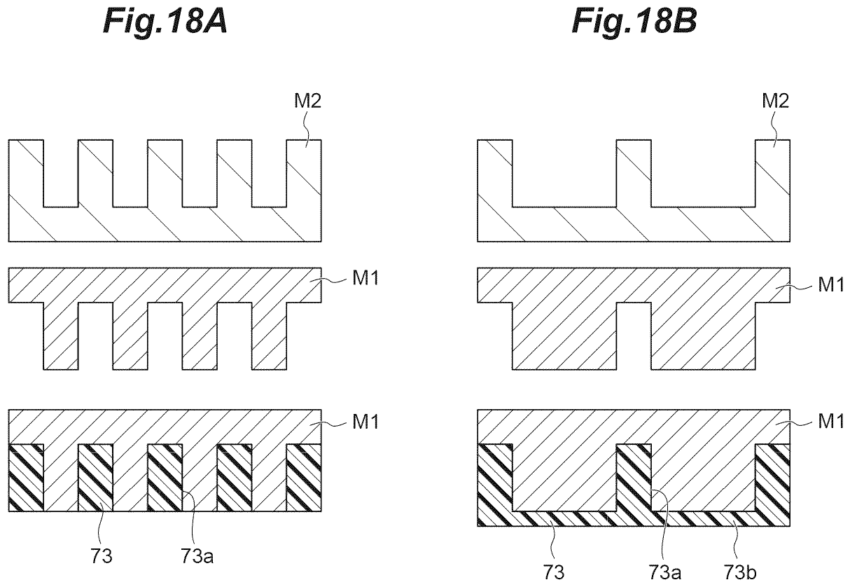

FIG. 18A and FIG. 18B are views illustrating a relationship between the opening density in the pattern structure portion and the amount of resin in the resist layer. FIG. 18A shows a case where the opening density is low, and FIG. 18B shows a case where the opening density is high. In each of FIG. 18A and FIG. 18B, a master mold M2, a working mold M1, and an imprint process using the working mold M1 are shown sequentially from the top. As shown in FIG. 18A and FIG. 18B, in a case where the opening density is high (the opening 73a of the resist layer 73 is small), the amount of resin in the resist layer 73 required to form the pattern portions is small. On the other hand, in a case where the opening density is low (the opening 73a is large), the amount of resin required to form the pattern portions is large. Accordingly, if there is a difference in the opening density depending on a position in the pattern portions, in a portion with high opening density, an excess resin is likely to remain on a bottom surface of the opening 73a as a residual film 73b (a difference in the thickness of the residual film 73b of the resist layer 73 may occur due to a difference in the opening density).

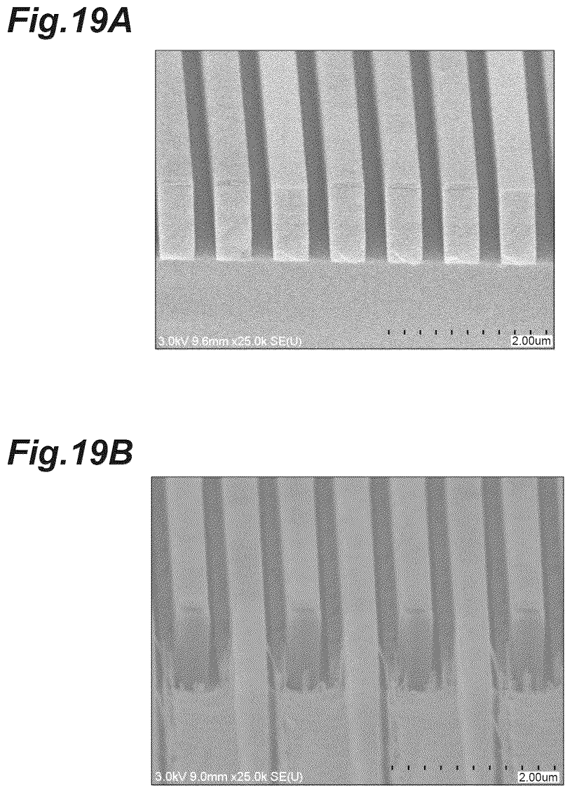

FIG. 19A and FIG. 19B are photographs illustrating a relationship between the opening density in the pattern structure portion and the residual film thickness of the resist layer. FIG. 19A shows a case where an opening density difference is small, and FIG. 19B shows a case where the opening density difference is large. In FIG. 19A, pattern portions are shown on rear side, and the opening density is uniform. In FIG. 19B, the opening density of a front side portion is higher than the opening density of a rear side portion, and the opening density difference is large. As shown in FIG. 19B, when the opening density difference is large, a residual film 73b remains after the etching process is completed. On the other hand, as shown in FIG. 19A, when the opening density difference is small, the pattern portions are formed in a satisfactory manner by the etching process. When the residual film 73b remains, it is considered that the

residual film 73b is removed by lengthening a residual film processing (etch-back) time or an etching (bosch) time, but there is a concern that dimensions may vary due to etching of a side surface of an etching target. In addition, there is a concern that a non-etching target region may be etched and exposed. In this regard, as described above, in the optical modulator 2 of the embodiment, since the first extension portions 53 and the second extension portions 63 are provided, it is possible to suppress occurrence of the opening density difference in the conductive portion 20, and it is possible to suppress the residual film 73b from remains. As a result, the pattern structure portion 21 can be stably formed.

The length L53 of the first extension portions 53 and the length L63 of the second extension portions 63 are equal to or greater than the arrangement period P of the first pattern portions 52 and the second pattern portions 62. According to this, the functional portion 22 can be formed more stably, and it is possible to suppress occurrence of dielectric breakdown due to abnormal electric field concentration in the modulation layer 30.

The length L53 of the first extension portions 53 is shorter than the length L52 of the first pattern portions 52, and the length L63 of the second extension portions 63 are shorter than the length L62 of the second pattern portions 62. According to this, the lengths L52 and L62 of the first pattern portions 52 and the second pattern portions 62 can be secured, and the size of the functional portion 22 can be secured.

The interval D1 between the first pattern portions 52 and the second extension portions 63 in the Y-direction, and the interval D2 between the second pattern portions 62 and the first extension portions 53 in the Y-direction are two or less times the arrangement period P of the first pattern portions 52 and the second pattern portions 62. According to this, it is possible to suppress occurrence of a difference in the opening density depending on a position in the conductive portion 20, and it is possible to stably form the pattern structure portion 21.

The interval between the first electrode portion 50 and the second electrode portion 60 is two or less times the arrangement period P of the first pattern portions 52 and the second pattern portions 62 at any position. According to this, it is possible to further suppress occurrence of a difference in the opening density depending on a position in the conductive portion 20, and it is possible to further stably form the pattern structure portion 21.

The reflection layer 40 is formed on the modulation layer 30. According to this, the optical modulator 2 can be configured in a reflection type.

The arrangement period P of the first pattern portions 52 and the second pattern portions 62 is from 0.5 μm to 15 μm. The arrangement period P of the first pattern portions 52 and the second pattern portions 62 is set, for example, to less than the wavelength of the target light L1. In the optical modulator 2, it is possible to modulate the target light L1 with a wavelength corresponding to the arrangement period P.

In the optical modulator 2 illustrated in FIG. 5, a plurality of the conductive portions 20 are two-dimensionally arranged on the substrate 10. According to this, it is possible to realize phase modulation by a two-dimensional modulation pattern by using a region corresponding to the two-dimensionally arranged conductive portions 20 as a modulation cell (modulation pixel).

The method for manufacturing the optical modulator 2 of the embodiment sequentially includes a process of arranging the resist layer 73 on the layer 72 corresponding to the conductive portion 20, a process of transferring the pattern shape M1a to the resist layer 73 by using the working mold M1 having at least the pattern shape M1a corresponding to the first pattern portions 52, the second pattern portions 62, the first extension portions 53, and the second extension portions 63, a process of etching the layer 72 by using the resist layer 73 as a mask to form the conductive portion 20, and a process of forming the modulation layer 30 on the substrate to cover at least the pattern structure portion 21 of the conductive portion 20. According to the method for manufacturing the optical modulator 2 of the embodiment, for the above-described reasons, it is possible to manufacture the optical modulator 2 that can stably modulate the target light L1.

In the method for manufacturing the optical modulator 2 of the above-described modification example, the pattern shape M1a of the working mold M1 includes a shape corresponding to the separation groove 18 that separates the conductive portions 20 from each other in addition to the first pattern portions 52, the first extension portions 53, the second pattern portions 62, and the second extension portions 63 of the conductive portion 20. In this case, the separation groove 18 can be formed by imprint lithography, and the manufacturing process can be simplified.

The present disclosure is not limited to the above-described embodiment and the above-described modification example. For example, the materials and the shapes of the respective configurations are not limited to the materials and the shapes described above, and various materials and shapes can be used. Although the optical modulator 2 in the above-described embodiment is configured as a reflection-type optical modulator, the optical modulator 2 may be configured as a transmission-type optical modulator. In this case, the reflection layer 40 is omitted.

The length L53 of the first extension portions 53 and the length L63 of the second extension portions 63 may be smaller than the arrangement period P of the first pattern portion 52 and the second pattern portion 62. The length L53 of the first extension portions 53 may be the same as or longer than the length L52 of the first pattern portions 52. The length L63 of the second extension portions 63 may be the same as or longer than the length L62 of the second pattern portions 62. The interval D1 between the first pattern portions 52 and the second extension portions 63 and/or the interval D2 between the second pattern portions 62 and the first extension portions 53 may be larger than the arrangement period P of the first pattern portions 52 and the second pattern portions 62 by two times.

The method for manufacturing the optical modulator 2 of the above-described embodiment may be applied for manufacturing the optical modulator 2 of the first or second reference example. That is, the method for manufacturing the optical modulator 2 of the above-described embodiment may be applied to the method for manufacturing the optical modulator 2 that is not provided with the first extension portions 53 and the second extension portions 63. In other words, the conductive portion 20 that does not include the first extension portions 53 and the second extension portions 63 may be formed by nanoimprint lithography. The method for manufacturing the optical modulator 2 in this case is “A method for manufacturing an optical modulator 2 including the substrate 10, the conductive portion 20 that includes the pattern structure portion 21 having a periodic arrangement and is formed on the substrate 10, the pattern structure portion 21 including the plurality of first pattern portions 52 extending in the Y-direction (first direction) orthogonal to the Z-direction (thickness direction of the substrate 10) and the plurality of second pattern portions 62 extending in the Y-direction and arranged alternately with the plurality of first pattern portions 52 in the X-direction (second direction) orthogonal to the Z-direction and the Y-direction, and the modulation layer 30 that is formed by an electro-optic polymer and is formed on the substrate 10 to cover at least the pattern structure portion 21, the method sequentially including: a process of disposing the resist layer 73 on the layer 72 corresponding to the conductive portion 20; a process of transferring the pattern shape M1a to the resist layer 73 by using the working mold M1 having at least the pattern shape M1a corresponding to the plurality of first pattern portions 52 and the plurality of second pattern portions 62; a process of etching the layer 72 corresponding to the conductive portion 20 by using the resist layer 73 as a mask to form the conductive portion 20; and a process of forming the modulation layer 30 on the substrate 10 to cover at least the pattern structure portion 21 of the conductive portion 20”. In this case, since the conductive portion 20 is formed by imprint lithography, for example, it is possible to shorten time for the manufacturing processes, and it is possible to realize a reduction in the cost and power consumption. In addition, it is possible to process a large area and a curved surface.

What is claimed is:

1. An optical modulator, comprising:
a substrate;
a conductive portion that includes a pattern structure portion having a periodic arrangement and is formed on the substrate; and
a modulation layer that is formed by an electro-optic polymer and is formed on the substrate to cover at least the pattern structure portion,
wherein the conductive portion includes a first electrode portion and a second electrode portion,
the first electrode portion includes a first base portion, and a plurality of first pattern portions extending from the first base portion in a first direction orthogonal to a thickness direction of the substrate, the second electrode portion includes a second base portion facing the first base portion in the first direction, and a plurality of second pattern portions extending from the second base portion in the first direction and arranged alternately with the plurality of first pattern portions in a second direction orthogonal to the thickness direction of the substrate and the first direction, the pattern structure portion including the plurality of first pattern portions and the plurality of second pattern portions, and
the first electrode portion further include a plurality of first extension portions extending from the first base portion toward the plurality of second pattern portions in the first direction, and the second electrode portion further include a plurality of second extension portions extending from the second base portion toward the plurality of first pattern portions in the first direction.

2. The optical modulator according to claim 1,
wherein a length of each of the plurality of first extension portions and a length of each of the plurality of second extension portions are equal to or greater than an arrangement period of the plurality of first pattern portions and the plurality of second pattern portions.

3. The optical modulator according to claim 1,
wherein a length of each of the plurality of first extension portions is shorter than a length of each of the plurality of first pattern portions, and a length of each of the plurality of second extension portions is shorter than a length of each of the plurality of second pattern portions.

4. The optical modulator according to claim 1,
wherein an interval between the plurality of first pattern portions and the plurality of second extension portions in the first direction, and an interval between the plurality of second pattern portions and the plurality of first extension portions in the first direction are two or less times an arrangement period of the plurality of first pattern portions and the plurality of second pattern portions.

5. The optical modulator according to claim 1,
wherein an interval between the first electrode portion and the second electrode portion is two or less times an arrangement period of the plurality of first pattern portions and the plurality of second pattern portions at any position.

6. The optical modulator according to claim 1, further comprising:
a reflection layer formed on the modulation layer.

7. The optical modulator according to claim 1,
wherein an arrangement period of the plurality of first pattern portions and the plurality of second pattern portions is 0.5 μm or more and 15 μm or less.

8. The optical modulator according to claim 1,
wherein a plurality of the conductive portions are one-dimensionally or two-dimensionally arranged on the substrate.

9. A method for manufacturing the optical modulator according to claim 1, the method sequentially comprising:
a process of disposing a resist layer on a layer corresponding to the conductive portion;
a process of transferring a pattern shape to the resist layer by using a mold having at least the pattern shape corresponding to the plurality of first pattern portions, the plurality of second pattern portions, the plurality of first extension portions, and the plurality of second extension portions;
a process of etching the layer corresponding to the conductive portion by using the resist layer as a mask to form the conductive portion; and
a process of forming the modulation layer on the substrate to cover at least the pattern structure portion of the conductive portion.

10. A method for manufacturing the optical modulator according to claim 8, the method sequentially comprising:
a process of disposing a resist layer on a layer corresponding to the plurality of conductive portions;
a process of transferring a pattern shape to the resist layer by using a mold having at least the pattern shape corresponding to the plurality of first pattern portions, the plurality of second pattern portions, the plurality of first extension portions, the plurality of second extension portions, and a separation groove that separates the plurality of conductive portions from each other;
a process of etching the layer corresponding to the plurality of conductive portions by using the resist layer as a mask to form the plurality of conductive portions; and
a process of forming the modulation layer on the substrate to cover the pattern structure portion of the plurality of conductive portions.
